(19) United States
(12) Patent Application Publication
(10) Pub. No.: US 2015/0273707 A1
(43) Pub. Date: Oct. 1, 2015

(54) Filleting Knife Blade

(71) Applicant: Michael A.N. Scobie, Quebec (CA)

(72) Inventor: Michael A.N. Scobie, Quebec (CA)

(21) Appl. No.: 14/670,454

(22) Filed: Mar. 27, 2015

Related U.S. Application Data
(60) Provisional application No. 61/971,807, filed on Mar. 28, 2014.

(51) Int. Cl. B26B 9/02; A22C 25/00; B26B 3/00; A22C 25/16

(52) U.S. Cl. CPC B26B 9/02; A22C 25/16; A22C 25/006; B26B 3/00

(57) ABSTRACT

A filleting knife blade is provided having a blade section, which includes an “ulu”-like flare or protrusion. The “ulu”-like protrusion offers a region of increased cutting pressure which is especially effective for cutting through fish skin and scales. Also, the curved shape of the “ulu”-like protrusion on the blade allows slicing of interior flesh in both directions parallel to the blade without fear of piercing internal organs or catching the blade tip. This is effective for peeling flesh way from bony structures such as the rib cage or spine, and is especially effective for filleting fish species such as bass or ling which have pronounced ribcage structures.

### FIELD OF THE INVENTION

The present invention relates to the field of knives, and in particular to a filleting knife blade construction.

### BACKGROUND OF THE INVENTION

A number of previous inventions have been developed and/or patented pertaining to knife blades designed specifically for filleting of fish. Also, various knife designs are commercially available today that are meant to perform this task. In general, there are two distinct knife blade types used for this purpose.

The first type is the long, thin filleting blade. Although the commercially available long blade filleting knives vary in style details, their general design features and functionality remain similar in nature.

For example, U.S. Pat. No. 4,825,552 (Bendickson, 1989) discloses a “fillet knife having a flexible handle”. Although this patent focuses only on an improved, more flexible handle, it does demonstrate the general design nature of the prior art; which is a long, thin and flexible blade narrowing continuously between the handle and the pointed blade tip, with the handle being in line with the blade.

This blade type has a number of positive attributes for filleting fish. Firstly, a pressure point can be created at the tip that can pierce the skin and scales of a fish allowing access to the interior flesh. Secondly, the length of blade allows thick portions of the flesh to be skewered before any sideways cutting motion takes place. Thirdly, due to the flexible nature of the blade, the flesh can be peeled away from the skin once the fillet has been separated from the fish. Fourthly, due to its fine nature, precision cuts can be made which is especially effective for separating flesh from bony structures like the ribcage and spine.

Conversely, there are limitations associated with the long filleting blade. Firstly, due to the relatively straight nature of the blade, pressure points cannot be created along the blade's length which can make lengthwise piercing of heavily scaled areas difficult. Secondly, when the blade tip is buried within the flesh, cutting motion can only effectively occur in one direction, towards the handle. Cutting motion away from the handle can frequently result in the blade tip getting caught or piercing of internal organs.

The second type of filleting blade design is based on the traditional Inuit “ulu” blade. A short, curved blade with the handle mounted above.

For example, U.S. Pat. No. 5,581,895 (Jeffcoat, 1996) discloses a “multipurpose knife with gut hook” consisting of an “ulu”-like curved blade with the handle mounted above the blade. Also, U.S. Pat. No. 5,033,987 (Bloch, 1991) discloses a “skinning and cutting knife” with different design details, but with similar blade and handle configurations.

This blade type has a number of positive attributes for filleting fish. Firstly, due to its curved nature, pressure points can be produced anywhere along the full tangential blade length which allow for easy penetration of scaly skin and chopping through bony structures. Secondly, since this blade does not have a tip, once it is buried within the flesh, cutting motion can occur in both directions, which maximizes cutting efficacy.

Conversely, there are limitations associated with the “ulu”-like filleting blade. Due to its compactness and handle position, it is not possible to skewer or achieve single, deep penetrations of the flesh. Shallower, incremental slices followed by spreading apart of the layers of flesh are instead necessary. Secondly, due to its bulky nature, precision movements required to separate flesh from bony structures such as the ribcage and spine, are difficult.

In addition, “ulu”-like blades have also been adapted for other applications as well. For example, U.S. Pat. No. 5,470,339 (Lerrick, 1995) discloses a “surgical scalpel safety blade”. Due to its curved shape, an advantage associated with this blade tip is that it can make incisions in both cutting directions. Also, due to its fine structure, precision movements required for accurate incisions are possible. However, the limitation of this blade is that the cutting surface is only at the end of the scalpel, and therefore it is also difficult to skewer or achieve single, deep penetrations of the flesh.

To overcome the limitations of both of these individual blade types, it would be advantageous to provide a knife, and a knife blade in particular, that combines characteristics of both prior art blade types in order to optimize functionality and performance.

### SUMMARY OF THE INVENTION

Accordingly, it is a principal advantage of the present invention to provide a filleting knife, and a filleting knife blade in particular, which exhibits characteristics of both the long blade and “ulu”-like blade types of filleting knives.

The advantages set out hereinabove, as well as other objects and goals inherent thereto, are at least partially or fully provided by the knife and knife blade of the present invention, as set out herein below.

Accordingly, in one aspect, the present invention provides a knife blade comprising a blade having a sharp edge extending along the length of said blade, side surfaces on either side of the blade, a blade tip at one end of the blade, and a blade spine having a top edge which extends along the length of the blade, wherein the blade additionally comprises a protrusion which extends outwards, and preferably radially outwards, from said sharp edge to form an “ulu”-like protrusion along its length. The “ulu”-like protrusion is preferably positioned substantially, or essentially, within the same plane as the overall blade. Furthermore, the “ulu”-like flare is preferably positioned towards the tip of the blade, and preferably adjacent to the tip of the blade.

With this arrangement, the blade section preferably comprises a long blade section at one end of the blade, a “ulu”-like section, and a blade tip section, all of which preferably have a sharp edge.

In a further aspect, the present invention also provides a knife having a handle section, and comprising the knife blade described hereinabove. The long blade section is typically adjacent to the handle section.

### DETAILED DESCRIPTION OF THE INVENTION

In the present application, the term “ulu”-like protrusion, or “flare”, refers to a preferably curved portion of the blade which widens out and then narrows to create a protrusion on the sharp edge of the blade. The protrusion can be any suitable size or shape, but typically its perimeter is curved. The terms, flare and protrusion, are intended to be similar and therefore interchangeable.

Preferably, the entire perimeter of the protrusion is sharpened and makes up a portion of the blade's cutting edge.

As a result of the “ulu”-like flare, an increased cutting pressure is created along the entire sharpened perimeter of the protrusion. This occurs during a typical cutting motion which is parallel to the overall knife length. This is especially advantageous during the action of filleting when attempting to pierce or cut through the skin or scales of a fish.

Also, as a result of the “ulu”-like flare, slicing of interior flesh can occur along the perimeter of the protrusion in both cutting directions; towards the blade's point as well as away from the blade's point. With a prior art long blade filleting knife, slicing of interior flesh in a direction towards the blade's point is difficult due to the point getting caught in the flesh. As such, use of the knife and knife blade of the present invention is advantageous when attempting to peel interior flesh away from bony structures such as the ribcage without piercing the internal organs of the fish. The blade of the present invention is therefore especially advantageous when filleting fish species such as bass or ling, which have pronounced ribcage structures.

Although the “ulu”-like flare can be positioned anywhere along the blade, it is preferable that it is positioned towards the blade's point and more preferably adjacent to the blade's point. In this way, the protrusion can be used like a scalpel without the blade's point interfering with the slicing action.

The “ulu”-like flare creates a “ulu”-like section that preferably extends between 10 and 50% of the length of the sharp edge of the knife blade, and more preferably extends between 20 and 40% of the length of the sharp edge. All, or greater than 50% of the “ulu”-like section is preferably located in the half of the knife blade which is distal from the knife handle section.

Additionally, the “ulu”-like flare also preferably creates a flared section that is up to 6 times the depth of a normal blade, without a “ulu”-like flare, in the area of the flared section. More preferably, the “ulu”-like flare creates a flared section that is between 1.1 and 4 times, and more preferably, between 1.5 and 2.5 times the normal blade depth, in the area of the flared section. However, values outside of these ranges are not specifically excluded.

The “ulu”-like flare is preferably positioned substantially or essentially within the same plane as the overall blade. This implies that the “ulu”-like protrusion is preferably substantially or essentially aligned with the knife blade, and the thickness of the blade is preferably not increased or decreased in the area of the “ulu”-like protrusion. However, the thickness of the blade in the area of the “ulu”-like protrusion may be increased or decreased by up to 50%, and more preferably increased or decreased by between 0 and 25%.

The blade of the present invention is also preferably flexible, which is intended to mean that the tip of the blade can flex side-to-side a distance which is between 10 and 50% of the length of the blade. However, it will be clear that use of a rigid blade which provides a blade wherein the tip flexes side-to-side by less than 10% is not excluded from the present invention.

As a result of the combination of the long blade section and the “ulu”-like flare, and preferably, the blade tip section, a knife or knife blade, or more preferably, a fish filleting knife or knife blade, is created that is more functional and better performing than the individual blades of the prior art.

Overall, it can be noted though, that the present application is primarily directed to the use of knives, and therefore, the construction of the knife and the knife blade will otherwise be in accordance with normal knife and knife blade production technology.

For example, the knife blade itself is preferably made of a metal, such as steel, and most preferably stainless steel. The handle section can be made from any suitable material, including wood, metal, ceramics, plastics, and the like, as is currently practised.

Moreover, the skilled artisan will also be aware that the knives and knife blades of the present invention can be used in a wide variety of applications. Accordingly, while the present application will be hereinafter described with respect to one type of knife blade, the skilled artisan would be aware that the present application is equally applicable in any other knife, or knife blade application.

The skilled artisan would be aware however, that the preferred embodiment of the present invention consists of a knife having a handle, and a knife blade, which knife blade consists of a long blade section, a “ulu”-like protrusion section, and a blade tip section, wherein a sharp edge extends through the long blade section, the “ulu”-like protrusion section, and the blade tip section.

### BRIEF DESCRIPTION OF THE DRAWINGS

Embodiments of this invention will now be described by way of example only in association with the accompanying drawings in which:

FIG. 1 is a side view of the prior art long filleting blade design;

FIG. 2 is a side view of the prior art “ulu”-like filleting blade design;

FIG. 3 is a side view of a knife blade of the present invention; and

FIG. 4 is a side view of a second embodiment of the present invention.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention. Also, unless otherwise specifically noted, all of the features described herein may be combined with any of the above aspects, in any combination.

The present invention utilizes the combination of long blade and “ulu”-like blade characteristics into one filleting blade thereby allowing multiple cutting techniques to be performed with the same blade. The long portion of the blade allows skewering and deep penetration of the flesh, while the “ulu”-like protruded portion of the blade produces areas of increased cutting pressure and allows fine cutting in both directions within the flesh which is advantageous when peeling flesh away from bony structures such as the ribcage and spine.

Referring to FIG. 1, a prior art knife 7 is shown which includes a knife blade 1, and a handle 2. Knife blade 1 includes a sharp edge 3 which extends along the length of blade 1, a side section 4, a blade spine 5 located at the top 6 of blade 1, and a blade point 8 at the tip of the blade. Blade 1 has a normal blade depth “x” which generally decreases when “x” is moved from the handle section 2 to blade point 8.

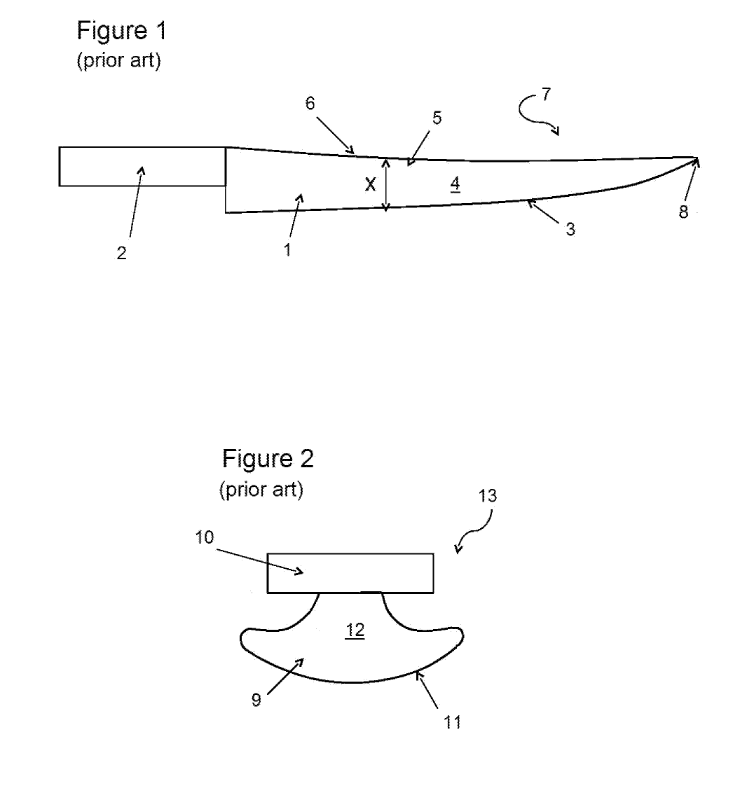

In FIG. 2, a second prior art knife 13 is shown, which includes an “ulu”-like blade 9, and a handle 10. Knife blade 13 includes a sharp edge 11, and a side section 12.

For clarity, the expression “ulu-like” in this document, is meant to imply a curved, sharp knife section, such as sharp edge 11.

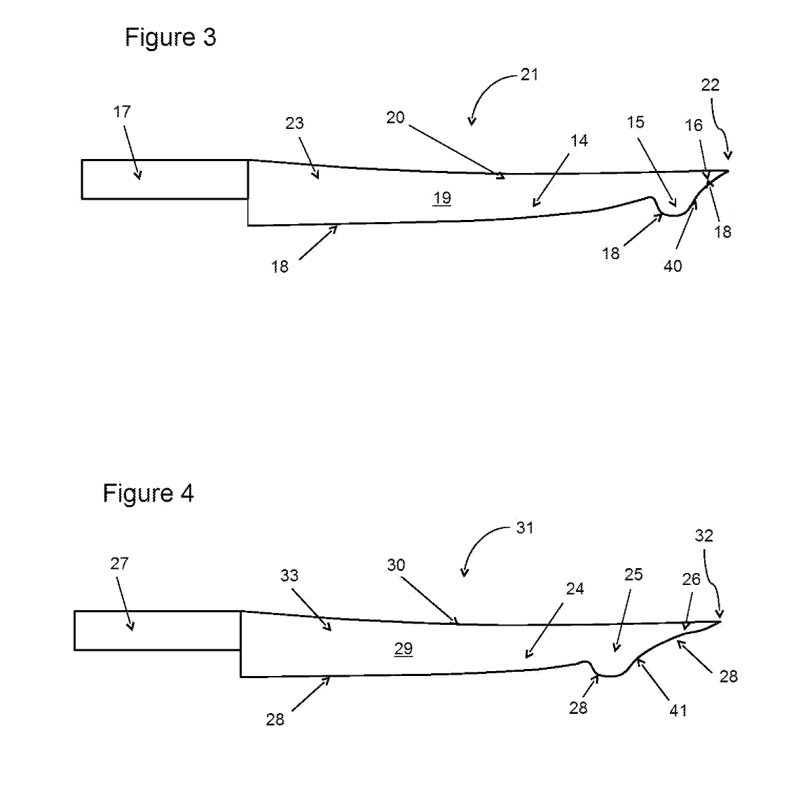

In FIG. 3, a knife 21 of the present invention is shown having a handle 17, and a blade section 14 having a side section 19, a blade spine 20, a blade point section 16, a blade tip 22, and an “ulu”-like blade protrusion section 15 which extends outwardly from blade section 14. As such, blade section 14 includes a long blade section 23, “ulu”-like section 15, and blade point section 16. Extending preferably along the length of blade section 14, including through long blade section 23, “ulu”-like section 15, and blade point section 16, is a sharp edge 18.

As mentioned earlier, the “ulu”-like blade protrusion can have any appropriate size or shape. For a knife blade having a length of 100 to 200 mm, the average length of the “ulu”-like blade protrusion is preferably from 5 mm to 50 mm, but more preferably is between 7 and 30 mm, and still more preferably, between 10 mm and 25 mm.

Additionally, the average depth of the “ulu”-like blade protrusion section, as defined by the distance between the section's spine 20 and its sharp edge 18, is preferably from 8 mm to 40 mm, but more preferably is between 10 mm and 25 mm, for a knife blade having a nominal, normal depth (i.e. the depth without the “ulu”-like section being present) of between 5 and 35 mm, and more preferably, a nominal, normal depth of between 5 and 20 mm.

Certain “ulu”-like protrusion shapes could be designed to optimize the filleting of specific fish species. The skilled artisan would be well aware that a variety of shapes and sizes can be utilized. Most preferably, however, the “ulu”-like protrusion forms a curved area which extends radially outward from the sharp edge of the blade. In one preferred embodiment, the “ulu”-like protrusion is a radial curve, having an essentially constant radius, which extends in a co-planar direction, outward from the sharp edge of the blade.

Additionally, the placement of the “ulu”-like blade protrusion can be anywhere along the length of the knife blade. The distance from the knife tip 22 to the tip-side edge 40 of the protrusion, defined as the blade tip section, is preferably between 1 mm and 100 mm, on a 100 to 200 mm blade, but more preferably is between 3 mm and 50 mm, and most preferably, between 3 and 10 mm. The length of the long blade section of the knife blade can vary, depending on the overall desired length of the knife blade.

The present invention can also be applied to larger or smaller blades. Typically, however, the length of the knife blade is between 75 and 300 mm, although even larger or smaller knife blade lengths are not excluded.

FIG. 4 shows a second embodiment of a knife 31 of the present invention, having a handle 27, and a blade section 24 having a side section 29, a blade spine 30, a blade point section 26, a blade tip 32, and a “ulu”-like blade protrusion section 25, which extends outwardly from blade section 24. As such, blade section 24 includes a long blade section 33, “ulu”-like section 25, and blade point section 26. Extending preferably along the length of blade section 24, including through long blade section 33, “ulu”-like section 25, and blade point section 26, is a sharp edge 28. In this embodiment, it will be noted that the distance from the knife tip 32 to the tip-side edge 41 of protrusion 25 has been increased.

Thus, it is apparent that there has been provided, in accordance with the present invention, a knife and knife blade which fully satisfy the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as falling within the scope of the amended claims.

Additionally, for clarity and unless otherwise stated, the word “comprise” and variations of the word such as “comprising” and “comprises”, when used in the description and claims of the present specification, is not intended to exclude other additives, components, integers or steps. Further, the invention illustratively disclosed herein suitably may be practised in the absence of any element which is not specifically disclosed herein.

Moreover, words such as “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “up”, “down”, “upper” or “lower”, or the like, is intended to be considered in respect of the normal orientation of the device.

Also, while this discussion has addressed prior art known to the inventor, it is not an admission that all art discussed is citable against the present application.

What is claimed is:

1. A knife blade comprising a blade having a sharp edge extending along the length of said blade, side surfaces on either side of the blade, a blade tip at one end of the blade, and a blade spine having a top edge which extends along the length of the blade, wherein the blade additionally comprises a protrusion which extends outwards from said sharp edge so as to form an “ulu”-like protrusion along at least a portion of said blade.

2. A knife blade as claimed in claim 1 wherein said “ulu”-like protrusion is positioned within the same plane as the overall blade.

3. A knife blade as claimed in claim 1 wherein said blade comprises a long blade section, a “ulu”-like section, and a blade tip section.

4. A knife blade as claimed in claim 3 wherein said long blade section is located adjacent to said “ulu”-like protrusion, and said blade tip section is located between said “ulu”-like protrusion and said blade tip.

5. A knife blade as claimed in claim 3 wherein said sharp edge makes up a cutting edge on said knife blade, and said sharp edge extends through said long blade section, said “ulu”-like section, and said blade tip section.

6. A knife blade as claimed in claim 4 wherein said “ulu”-like protrusion comprises a sharp edge which is curved.

7. A knife blade as claimed in claim 6 wherein said protrusion extends radially outward from said blade.

8. A knife blade as claimed in claim 7 wherein said protrusion has an essentially constant radius, which radius extends in a co-planar direction, outward from the sharp edge of the blade.

9. A knife comprising a knife handle, and the knife blade as claimed in claim 1.
